(19) United States
(12) Patent Application Publication
(10) Pub. No.: US 2019/0247850 A1
(43) Pub. Date: Aug. 15, 2019

(54) COMPACT MULTI MOLECULAR DIAGNOSIS SYSTEM AND COMPACT MULTI MOLECULAR DIAGONSIS APPARATUS

(71) Applicant: KOREA INSTITUTE OF SCIENCE AND TECHNOLOGY, Seoul (KR)

(72) Inventors: Sangyoup LEE, Seoul (KR); Junho Choi, Seoul (KR); Sehoon Kim, Seoul (KR); Daewoong Lee, Seoul (KR); Seunghan Park, Seoul (KR); Cherlhyun Jeong, Seoul (KR)

(73) Assignee: KOREA INSTITUTE OF SCIENCE AND TECHNOLOGY, Seoul (KR)

(21) Appl. No.: 16/225,472

(22) Filed: Dec. 19, 2018

(30) Foreign Application Priority Data
Feb. 12, 2018 (KR) 10-2018-0017218
Feb. 12, 2018 (KR) 10-2018-0017219

(51) Int. Cl. B01L 3/00

(52) U.S. Cl. CPC B01L 3/50851; B01L 2300/1805; B01L 2300/0816; B01L 3/502715

(57) ABSTRACT

In a compact multi molecular diagnosis system and a multi molecular diagnosis apparatus, the multi molecular diagnosis system includes a card part, a pretreatment and collector, a cleaner, a reagent unit, a heater and an optical unit. The card part moves in a rotating frame, and has a plurality of cards. The pretreatment and collector provides a collected specimen to each card of the card part. The cleaner provides a cleaning liquid to the card part, to clean the collected specimen in the card part. The reagent unit provides a plurality of diagnosis reagents to each card of the card part. The heater heats the card part absorbing the reagent, to clone a virus template. The optical unit observes the cloned virus template. The card part sequentially moves through the pretreatment and collector, the cleaner, the reagent unit, the heater and the optical unit.

This application claims priority under 35 U.S.C. § 119 to Korean Patent Applications No. 10-2018-0017218, filed on Feb. 12, 2018, and No. 10-2018-0017219, filed on Feb. 12, 2018, the disclosures of which are incorporated by reference herein in their entireties.

### BACKGROUND

### 1. Field of Disclosure

The present disclosure of invention relates to multi molecular diagnosis system and multi molecular diagnosis apparatus, and more specifically the present disclosure of invention relates to multi molecular diagnosis system and multi molecular diagnosis apparatus, used for multi molecular diagnosis technology using a paper performing pretreatment to measurement automatically, and being manufactured with a portable or relatively small device.

### 2. Description of Related Technology

Molecular diagnosis technology is widely used in medicine and biology, for detecting hereditary disorder, confirming genetic fingerprinting, diagnosing infectious disease, gene cloning, confirming paternity test, or DNA computing.

For example, polymerase chain reaction (PCR) device is an example DNA amplification technology, and is widely used due to fast molecular diagnosis, but has a limitation in multi molecular diagnosis.

Korean laid-open patent number 10-2016-0020766 discloses absorbance multi measuring apparatus for a real time molecular diagnosis, and in the multi measuring apparatus, multi samples are measured, temperature is controlled and a structure thereof is more simplified, such that the real time molecular diagnosis may be performed. However, multi measurement is only performed in absorbance measurement, and other steps for the molecular diagnosis are individually performed or are not performed automatically.

In paper molecular diagnosis technology, FTA card is used, and thus relatively low price and simple process are necessary for the molecular diagnosis. However, each step should be performed manually, and in the manual process, secondary infection may be possible.

In addition, the paper may be damaged in each process for the molecular diagnosis. Further, in the paper, signal to noise ratio may be increased due to an intrinsic fluorescence, or a drying process may be necessary in each process of the diagnosis.

### SUMMARY

The present invention is developed to solve the above-mentioned problems of the related arts. The present invention provides multi molecular diagnosis system and multi molecular diagnosis apparatus, capable of multi molecular diagnosis using a paper from pretreatment to measurement automatically, and capable of being manufactured with a portable or relatively small device.

According to an example embodiment, the multi molecular diagnosis system includes a card part, a pretreatment and collector, a cleaner, a reagent unit, a heater and an optical unit. The card part moves in a rotating frame, and has a plurality of cards. The pretreatment and collector provides a collected specimen to each card of the card part. The cleaner provides a cleaning liquid to the card part, to clean the collected specimen in the card part. The reagent unit provides a plurality of diagnosis reagents to each card of the card part. The heater heats the card part absorbing the reagent, to clone a virus template. The optical unit observes the cloned virus template. The card part sequentially moves through the pretreatment and collector, the cleaner, the reagent unit, the heater and the optical unit.

In an example, the multi molecular diagnosis system may further include a specimen absorber disposed under the pretreatment and collector, and absorbing the specimen passing through the card part, a cleaning liquid absorber disposed under the cleaner, and absorbing the cleaning liquid passing through the card part, and a reagent absorber disposed under the reagent unit, and absorbing the reagent passing through the card part.

In an example, the card part may be adhered between the pretreatment and collector and the specimen absorber, between the cleaner and the cleaning absorber, and between the reagent unit and the reagent absorber.

In an example, the card part may be fixed to the rotating frame, and the rotating frame may be rotated with respect to a central axis.

In an example, the card part may be positioned under each of the pretreatment and collector, the cleaner, the reagent unit and the heater, as the rotating frame is rotated.

In an example, a dividing portion dividing the card part into the plurality of cards may include a wax, to block the specimen from being infiltrated into an adjacent card.

In an example, the pretreatment and collector may receive the specimen from a tube upwardly, and provide the specimen to each of the cards individually.

In an example, the pretreatment and collector may include a plurality of needles respectively positioned at the cards.

In an example, the pretreatment and collector may include a plurality of collecting conduits disposed at the cards of the card part and connecting the tube to the cards, respectively.

In an example, the reagent unit may include a plurality of reagent conduits disposed at the cards of the card part and providing the reagents different from each other to the cards, respectively.

In an example, the card part may be FTA card.

In an example, a size and a density of a pore in the card part may be changed, to control passing speeds of the specimen, the cleaning liquid and the diagnosis reagents.

According to another example embodiment, a multi molecular diagnosis apparatus includes a card part, a pretreatment and collector, a cleaner, a reagent unit, a heater and a rotating frame. The pretreatment and collector provides a collected specimen to the card part. The cleaner provides a cleaning liquid to the card part, to clean the collected specimen in the card part. The reagent unit provides a diagnosis reagent to the card part. The heater heats the card part absorbing the reagent, to clone a virus template. The rotating frame moves the card part to the pretreatment and collector, the cleaner, the reagent unit and the heater, and provides a moving space when the card part moves.

In an example, the rotating frame may include a lower surface frame fixed at a base frame, an upper surface frame facing the lower surface frame, and a vertical fixing guide connecting the upper surface frame and the lower surface frame to the base frame.

In an example, the rotating frame further may include a lower frame fixed to an upper surface of the lower surface frame, an upper frame fixed to a lower surface of the upper surface frame, and a central frame disposed between the lower frame and the upper frame, and rotating with respect to a central axis.

In an example, the upper surface frame may move up and down along the vertical fixing guide, as the central frame is rotated.

In an example, the upper surface frame may move upwardly to form a moving space of the card part, as the card part moves. The upper surface frame may move downwardly to attach the card part to one of the pretreatment and collector, the cleaner, the reagent unit and the heater, as the card part is attached.

In an example, a convex portion and a concave portion may be alternately extended, at each of the lower frame, the upper frame and the central frame. The upper surface frame may move upwardly as the convex portions make contact with each other, and the upper surface frame may move downwardly as the convex portion makes contact with the concave portion.

In an example, an inclined surface may be formed between the convex and concave portions, and thus the protrusion of the central frame may move along the inclined surface to make contact with the protrusion of the lower frame and the protrusion of the upper frame as the central frame is rotated.

In an example, the lower frame, the upper frame and the central frame may form a side surface of a polyprism.

According to the example embodiments of the present invention, each process is performed manually in the conventional paper molecular diagnosis, but in the present example embodiment, a series of processes are performed automatically in the molecular diagnosis, to enhance user's convenience.

In addition, the card part is rotated in the rotating frame, and each unit performing each process is arranged in a rotational shape, so that a total volume of the diagnosis system is minimized Thus, the diagnosis system may be performed to be portable and a relatively small size.

In addition, with other diagnosis units fixed in the position, the rotating frame in which the paper is positioned is rotated, and thus the system may be more simplified, the diagnosis speed may be increased and the system may be manufactured more easily.

Here, the rotation of the rotating frame forms the moving space in which the card part is to be moved, and the card part is attached to the unit when each diagnosis process is performed with the stop of the rotating frame, so that the card part may be prevented from being damaged and the diagnosis may be stably performed.

In addition, the diagnosis process is performed within an enclosed space, and thus second infection may be prevented.

In addition, in the conventional process of using the Whatman FTA card, a drying process is necessary in each process, but, in the present example embodiment, any drying process is unnecessary in an entire diagnosis process.

In addition, the unit providing the specimen, the cleaning liquid or the diagnosis reagent is disposed over the card part, and the unit absorbing the specimen, the cleaning liquid or the diagnosis reagent is disposed under the card part. Thus, the liquid from upside is effectively absorbed at the downside, so that the liquid easily passes through the card part and the diagnosis process may be performed more efficiently.

In addition, the card part is divided by a plurality of areas, and the specimen is prevented from being infiltrated from an adjacent area, so that the multi molecular diagnosis in which different reagents are used in every area may be performed.

In addition, the rotating frame is designed considering that a plurality of diagnosis processes is sequentially performed and the card part is repeatedly stopped and moved for each diagnosis process, so that the system is configured to be relatively simple structure to prevent the card part from being damaged and every diagnosis process is stably performed.

Here, the convex and concave portions of the central frame, the upper frame and the lower frame are alternately repeated, and the upper surface frame is moved up and down, so that the upper surface frame moves upwardly to form the moving space for the card part when the convex portion of the central frame makes contact with the convex portions of the lower and upper frames. Thus, the optimized multi molecular diagnosis apparatus may be provided, considering the characteristics of the multi molecular diagnosis system in which repeated moving spaces and the attaching are necessary.

### BRIEF DESCRIPTION OF THE DRAWINGS

FIG. 1 is a perspective view illustrating a multi molecular diagnosis system according to the present example embodiment of the present invention;

FIG. 2 is an exploded perspective view illustrating a multi molecular diagnosis system of FIG. 1;

FIG. 3 is a plane view illustrating a card part of FIG. 1;

FIG. 4 is a perspective view illustrating a pretreatment and collector, a tube and a first absorber of FIG. 1;

FIG. 5 is a perspective view illustrating a reagent unit and a fourth absorber of FIG. 1;

FIG. 6 is a perspective view illustrating a pretreatment and collector, a tube and a first absorber of a multi molecular diagnosis system according to another example embodiment of the present invention;

FIG. 7A is a plan view illustrating a card holder at which a card part is fixed, in a multi molecular diagnosis system according to still another example embodiment of the present invention, and FIG. 7B is a cross-sectional view take along a line I-I′ of FIG. 7B;

FIG. 8 is a perspective view illustrating a multi molecular diagnosis apparatus according to still another example embodiment of the present invention;

FIG. 9 is a perspective view illustrating a rotating frame unit of FIG. 8 with a fixed state;

FIG. 10 is a side view illustrating the rotating frame unit of FIG. 9;

FIG. 11 is a perspective view illustrating the rotating frame unit of FIG. 8 with a rotated state;

FIG. 12 is a side view illustrating the rotating frame unit of FIG. 11;

FIG. 13 is an enlarged view illustrating a pretreatment and collector with the rotating frame unit of FIG. 8 rotated;

FIG. 14 is an enlarged view illustrating the rotating frame unit of FIG. 8 with a collected state;

FIG. 15 is an enlarged view illustrating a cleaner with the rotating frame unit of FIG. 8 rotated; and

FIG. 16 is an enlarged view illustrating the rotating frame unit of FIG. 8 with a heated state.

### DETAILED DESCRIPTION

The invention is described more fully hereinafter with Reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

The terminology used herein is for the purpose of describing particular embodiments only and is not intended to be limiting of the invention.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

In addition, the same reference numerals will be used to refer to the same or like parts and any further repetitive explanation concerning the above elements will be omitted. Detailed explanation regarding prior arts will be omitted not to increase uncertainty of the present example embodiments of the present invention.

Hereinafter, the embodiments of the present invention will be described in detail with reference to the accompanied drawings.

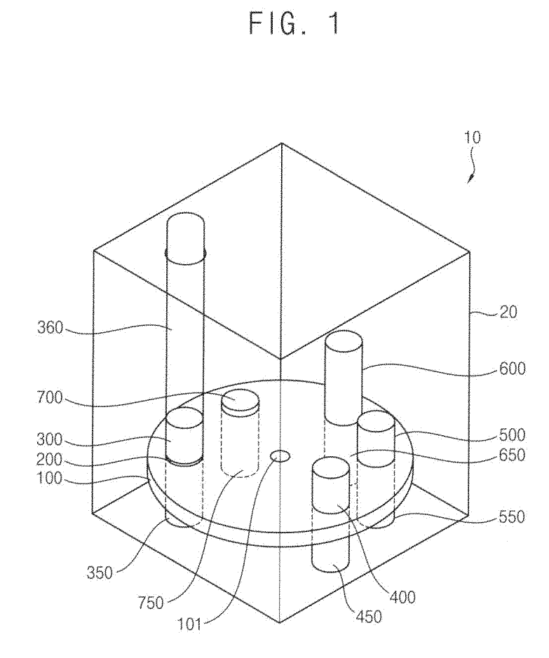

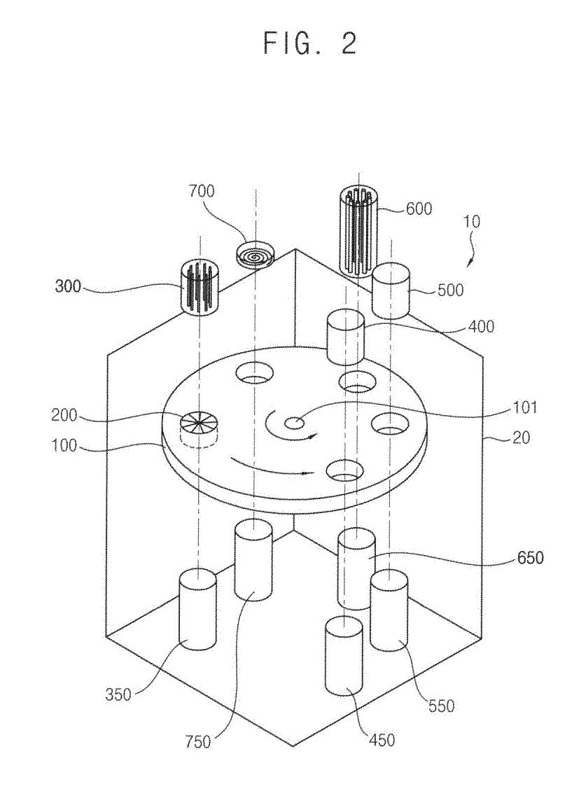

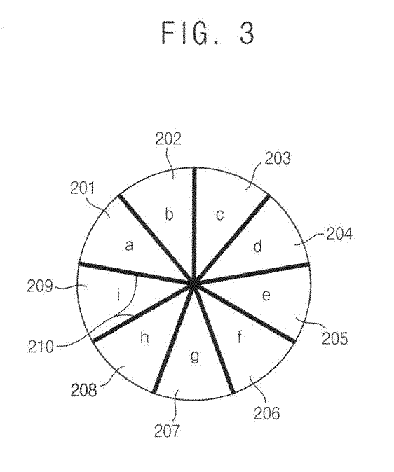

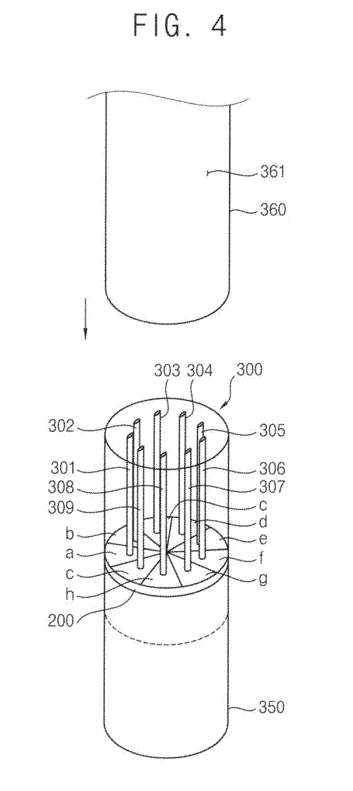

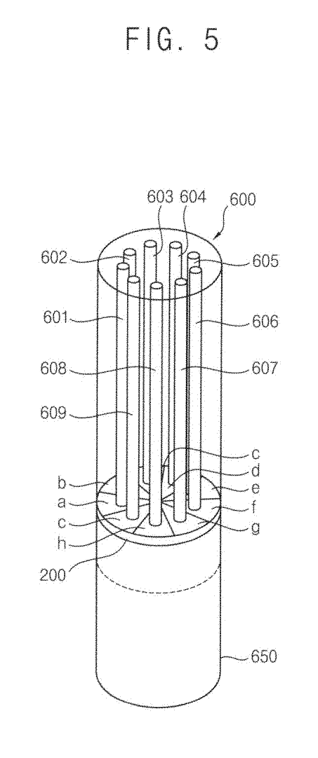

FIG. 1 is a perspective view illustrating a multi molecular diagnosis system according to the present example embodiment of the present invention. FIG. 2 is an exploded perspective view illustrating a multi molecular diagnosis system of FIG. 1. FIG. 3 is a plane view illustrating a card part of FIG. 1. FIG. 4 is a perspective view illustrating a pretreatment and collector, a tube and a first absorber of FIG. 1. FIG. 5 is a perspective view illustrating a reagent unit and a fourth absorber of FIG. 1.

Referring to FIGS. 1 to 5, the multi molecular diagnosis system 10 (hereinafter, so called as ‘system’) includes an outer frame 20, a rotating frame 100, a card part 200, a pretreatment and collector 300, a specimen absorber 350, a first cleaner 400, a first cleaning liquid absorber 450, a second cleaner 500, a second cleaning liquid absorber 550, a reagent unit 600, a reagent absorber 650 and a heater 700, and may further include an optical unit although not shown in the figure.

The outer frame 20, as illustrated in the figure, may have a rectangular block, or may have various kinds of shapes like a cylindrical shape, and has a space inside of the outer frame 20 in which the units mentioned below are positioned.

In addition, when the molecular diagnosis is performed, the outer frame 20 encloses the units from outside to prevent infection in the molecular diagnosis, and an upper surface or a side surface of the outer frame 20 may be open before or after the diagnosis.

The system 10 according to the present example embodiment is a disposable and portable, so that the size of the system may be relatively small.

The rotating frame 100 is positioned at a central portion of the inner space of the outer frame 20, and is rotated with respect to a central axis 101. The rotating frame 100, as illustrated in the figure, may have a circular plate shape with a predetermined thickness, and the card part 200 is positioned at a side of the rotating frame 100.

Thus, as the rotating frame 100 is rotated with respect to a central axis 101, the card part 200 is also rotated, and the card part 200 is sequentially positioned under the pretreatment and collector 300, the first and second cleaners 400 and 500, the reagent unit 600 and the heater 700, for performing each process of the molecular diagnosis.

Thus, the pretreatment and collector 300, the first and second cleaners 400 and 500, the reagent unit 600 and the heater 700 are fixed and arranged around the circular frame 100 and are aligned along the card part at each process.

Here, each of the pretreatment and collector 300, the first and second cleaners 400 and 500, the reagent unit 600 and the heater 700 may be positioned with the same distance from the center of the rotating frame 100, or may be positioned with predetermined distances different from each other from the center of the rotating frame 100 considering each process.

However, considering the diagnosis process, when the rotating frame 100 is rotated counterclockwise, the pretreatment and collector 300, the first and second cleaners 400 and 500, the reagent unit 600 and the heater 700 are sequentially arranged along a counterclockwise direction.

In addition, the space is formed at a side of the rotating frame 100 for the card part 200 to be positioned, and the card part 200 is rotated with positioned in the space.

The card part 200, as illustrated in FIG. 3, may have a circular paper shape with a predetermined thickness, and a virus is detected by the card part 200 with the specimen and the diagnosis reagent being infiltrated and with a virus template being amplified isothermally.

Here, the specimen may be blood, sputum, stool, epithelial cell, and so on.

For example, the card part 200 may be ‘Whatman FTA card’ which is conventionally used in the paper molecular diagnosis.

In addition, the card part 200 has a pore insidethereof for the specimen, the diagnosis reagent or the cleaning liquid to pass through, and a size and a density of the pore of the card part 200 may be variously formed, so that a passing speed of the specimen, the diagnosis reagent or the cleaning liquid may be controlled.

For example, the difference among a capillary force of pores disposed beneath of each of the pretreatment and collector 300, the first cleaner 400, the second cleaner 500 and the reagent unit 600, a capillary force of the pores of the card part 200, and a capillary force of pores disposed on the specimen absorber 350, the first cleaning liquid absorber 450, the second cleaning liquid absorber 550 and the reagent absorber 650, are properly controlled, so that the passing speed of the specimen may be controlled. Accordingly, capillarity of the pores may be used for the controlling.

Here, the card part 200 is divided into a plurality of areas (for example, 1 to 9 areas) (201, 202, . . . , 209 or a, b, . . . i), and the reagents different from each other are respectively provided to the areas different from each other, so that the multi molecular diagnosis may be performed with a single molecular diagnosis process.

Here, the number of the areas may be variously formed considering the number of diagnoses.

In the present example embodiment, a dividing portion 210 is formed in the card part 200 to prevent the specimen or the diagnosis reagent from being infiltrated to an adjacent area, and the dividing portion 210 may include a wax to block the infiltration.

Alternatively, although not shown in the figure, the card part 200 may have a divided shape at each area, and then each area is attached to form the card part 200 as illustrated in FIG. 3, and then the specimen or the diagnosis reagent may be prevented from being infiltrated to an adjacent area.

The card part 200 is initially positioned under the pretreatment and collector 300, and receives the specimen from the pretreatment and collector 300.

The pretreatment and collector 300, as illustrated in FIGS. 2 and 4, includes a pretreatment and collector cover and a plurality of needles, and a tube 360 is combined to an upper of the pretreatment and collector 300.

The tube 360, for example is an EDTA tube, and saves the specimen 361 from a human body. In the present example embodiment, the upper of the pretreatment and collector 300 may have a shape and a size to be matched with the shape and the size of an end of the EDTA tube, so that the EDTA tube may be easily inserted into the pretreatment and collector 300.

Then, after the tube 360 having the specimen is combined with the pretreatment and collector 300, the specimen is provided to the card part 200 via the pretreatment and collector 300.

Here, the plurality of needles is arranged in the pretreatment and collector 300, and each of the needles (for example, 1 to 9 needles) (301, 302, . . . , 309) is arranged at each of the areas (a, b, . . . , i) of the card part 200.

In addition, each of the needles has a sharp end to penetrate the tube 360, and thus the specimen inside of the tube 360 is provided to each of the areas of the card part 200.

In the present example embodiment, when the card part 200 is aligned with the pretreatment and collector 300, the specimen absorber 350 is positioned under the card part 200 and is aligned with the pretreatment and collector 300.

In addition, the card part 200 is tightly adhered to the specimen absorber 350, and thus the specimen provided to the card part 200 is absorbed by the specimen absorber 350 and then the specimen passes through the card part 200.

In the present example embodiment, until the specimen passes through the card part 200 and is absorbed by the specimen absorber 350, the specimen is merely dropped by the gravity and any additional driving force is unnecessary, and thus any additional driving unit for dropping the specimen is unnecessary. Likewise, any additional driving units are unnecessary in the first and second cleaning liquid absorbers 450 and 550 and the reagent absorber 650.

Accordingly, the specimen is absorbed at each area of the card part 200, and then the rotating frame 100 is rotated. Then, the card part 200 is positioned under the first cleaner 400.

The first cleaner 400, as illustrated in the figure, may have a cylindrical shape with a shape and a size substantially same as those of the card part 200, and a cleaning liquid is saved in the first cleaner 400 to clean the specimen absorbed by the card part 200.

In addition, when the card part 200 is aligned with the first cleaner 400, the first cleaning liquid absorber 450 is positioned under the card part 200 and is aligned with the first cleaner 400. Further, the first cleaning liquid absorber 450 is also tightly adhered to the card part 200.

Then, the cleaning liquid provided from the first cleaner 400 passes through the card part 200 to be absorbed by the first cleaning liquid absorber 450, and thus the specimen absorbed in the card part 200 is firstly cleaned.

Likewise, after the specimen is cleaned by the first cleaner 400, the card part 200 is positioned under the second cleaner 500 due to the rotation of the rotating frame 100.

The second cleaner 500, as illustrated in the figure, may have a cylindrical shape with a shape and a size substantially same as those of the card part 200, and a cleaning liquid is saved in the second cleaner 500 to clean the specimen absorbed by the card part 200.

Here, the cleaning liquid of the second cleaner 500 is different from that of the first cleaner 400, and the contents like a blood plasma included in the specimen except for the template is removed and cleaned by the first and second cleaners 400 and 500.

In addition, the number of the cleaners may be variously changed.

When the card part 200 is aligned with the second cleaner 500, the second cleaning liquid absorber 550 is positioned under the card part 200 and is aligned with the second cleaner 500. In addition, the second cleaning liquid absorber 550 is also tightly adhered to the card part 200.

Then, the cleaning liquid from the second cleaner 500 passes through the card part 200 and is absorbed by the second cleaning liquid absorber 550, and then the specimen absorbed by the card part 200 is additionally cleaned.

Accordingly, when the card part 200 is cleaned by the first and second cleaners 400 and 500, the nucleic acid like DNA or RNA is only remained in the specimen absorbed by the card part 200.

Then, the rotating frame 100 is additionally rotated, and then the card part 200 is disposed under the reagent unit 600.

Likewise, when the card part 200 is disposed under the reagent unit 600, the reagent absorber 650 aligned with the reagent unit 600 is tightly adhered to a lower surface of the card part 200.

Here, as illustrated in FIG. 5, the reagent unit 600 includes a unit cover and a plurality of reagent conduits. For example, the reagent conduits may include first to nine reagent conduits 601, 602, . . . , 609.

Then, each of the reagent conduit is disposed at each of the first to nine areas a, b, . . . , i of the card part 200.

Each of the reagent conduit 601, 602, . . . , 609 includes a reagent different from other reagents, and is opened when positioned under the card part 200. Then, the reagents different from each other are respectively provided to the first to nine areas a, b, . . . , i of the car 200, individually. Here, each of the nine areas receives different reagent.

The reagent is provided into the reagent conduit in advance, to detect a virus or a bacterium included in the specimen.

In addition, the areas of the card part 200 are divided by the dividing portion 210, and thus the reagent different from each other is prevented from being infiltrated to other area. Thus, a proper detection may be performed via using the proper reagent determined in advance.

In addition, the reagents provided from the reagent conduits 601, 602, . . . , 609 are absorbed by the reagent absorber 650 adhered to the lower surface of the card part 200.

Accordingly, with each of the reagents different from each other absorbed in each area of the card part 200 having the virus template, the card part 200 is rotated to be disposed under the heater 700.

Here, an additional absorber 750 may be disposed under the heater 700, with aligned with the heater 700, and the additional absorber 750 is tightly adhered to the lower surface of the card part 200. Thus, the impurities evaporated or generated in the heating may be absorbed by the additional absorber 750.

The heater 700 heats each area of the card part 200, and then the virus template remaining in the card part 200 is amplified. Here, due to the amplification of the virus template, the virus may be detected by the optical unit more easily.

Although not shown in the figure, an additional optical unit may be disposed adjacent to the heater 700, or may be moved into the outer frame 20.

Then, the optical unit may detect the virus in each area of the card part 200. For example, the area in which the reagent is reacted may be detected as a yellow color by the optical unit, and then the virus or the bacterium in the specimen may be finally detected.

Accordingly, the multi molecular diagnosis system in the present example embodiment may detect the virus or the bacterium in the specimen, much faster or automatically, and here, individual diagnosis may be performed by each reagent provided or applied to each area.

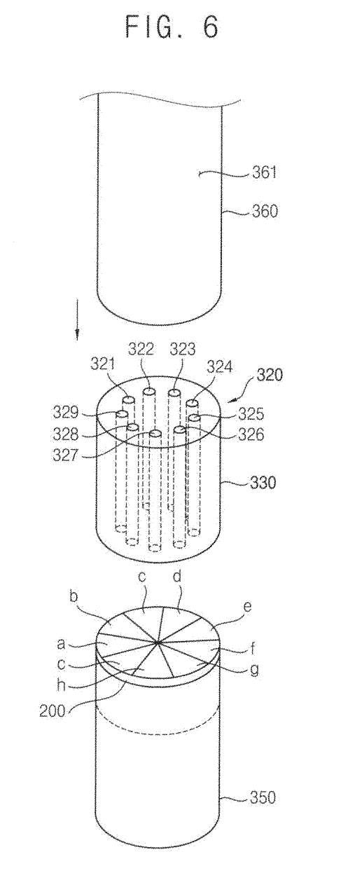

FIG. 6 is a perspective view illustrating a pretreatment and collector, a tube and a first absorber of a multi molecular diagnosis system according to another example embodiment of the present invention.

The multi molecular diagnosis system according to the present example embodiment is substantially same as the system explained referring to FIGS. 1 to 5, except for a shape and a structure of a pretreatment and collector 320, and thus same reference numerals are used for same elements and any repetitive explanation will be omitted.

Referring to FIG. 6, in the multi molecular diagnosis system of the present example embodiment, the pretreatment and collector 320 has a circular shape in a whole, and a plurality of collecting conduits is formed inside of an outer shape 330.

For example, the collecting conduits may be first to nine collecting conduits 321, 322, . . . , 329, and each of the collecting conduits may have a conduit shape passing through an inside of the outer shape 330.

The collecting conduits 321, 322, . . . , 329 are individually and respectively disposed in the first to nine areas a, b, . . . , i. In addition, the tube 360 is combined with the pretreatment and collector 320, and the tube 360 may be the EDTA tube storing the specimen 361 as explained above, and thus an upper portion of the pretreatment and collector 320 has a shape and a size suitable for the EDTA tube.

Then, when the tube 360 is combined with the pretreatment and collector 320, the specimen is provided to each of the areas a, b, . . . , i through each of the collecting conduits 321, 322, . . . , 329 of the pretreatment and collector 320.

Here, when the card part 200 is aligned with the pretreatment and collector 320, as explained above, the specimen absorber 350 aligned with the pretreatment and collector 320 is disposed under the card part 200, and thus the specimen provided to the card part 200 is absorbed by the specimen absorber 350 and the specimen passes through the card part 200.

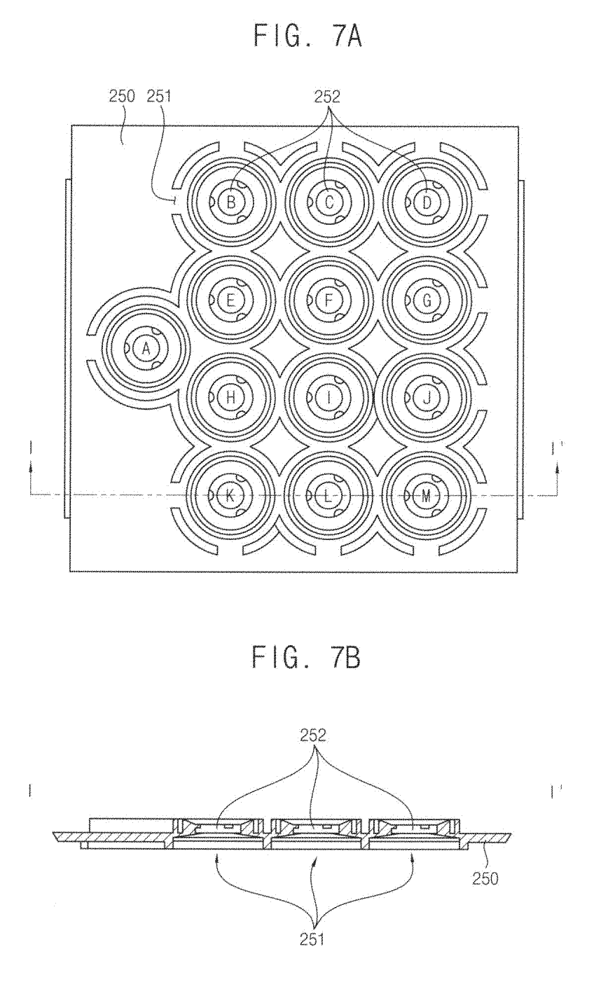

FIG. 7A is a plan view illustrating a card holder at which a card part is fixed, in a multi molecular diagnosis system according to still another example embodiment of the present invention, and FIG. 7B is a cross-sectional view take along a line I-I′ of FIG. 7B.

The multi molecular diagnosis according to the present example embodiment is substantially same as the multi molecular diagnosis explained referring to FIGS. 1 to 6, except for a card part and a card holder fixing the card part, and thus same reference numerals are used for same elements and any repetitive explanation will be omitted.

Referring to FIGS. 7A and 7B, the multi molecular diagnosis according to the present example embodiment further includes a card holder 250. In addition, the card part 252 includes a plurality of cards, and each of the cards A˜M is fixed to the card holder 250.

Here, the card holder 250 may have a plate shape, and may be divided into a plurality of card areas 251. Thus, each of the cards A˜M is disposed at each of the card areas 251.

Accordingly, each card is disposed at each card area divided with an adjacent card area, and thus each diagnosis reagent is provided to each card disposed at each card area.

Further, each process performed at each area of the card part 200, which is mentioned in the previous example embodiment, is performed substantially same at each card of the card part 252.

Here, the number of the card areas 251 of the card holder 250, and the number of the cards may be variously selected or changed considering the number of the multi diagnosis.

Thus, compared to the multi diagnosis process performed in a single card part which is divided into the plurality of areas, in the present example embodiment, the card is separated and divided more definitely and more stably and thus cross-contamination with the adjacent card may be stably prevented.

Accordingly, the system 10 according to the present example embodiment has been explained referring to the figures.

Hereinafter, a multi molecular diagnosis apparatus 30 performed using the multi molecular diagnosis system 10 explained above, will be explained in detail.

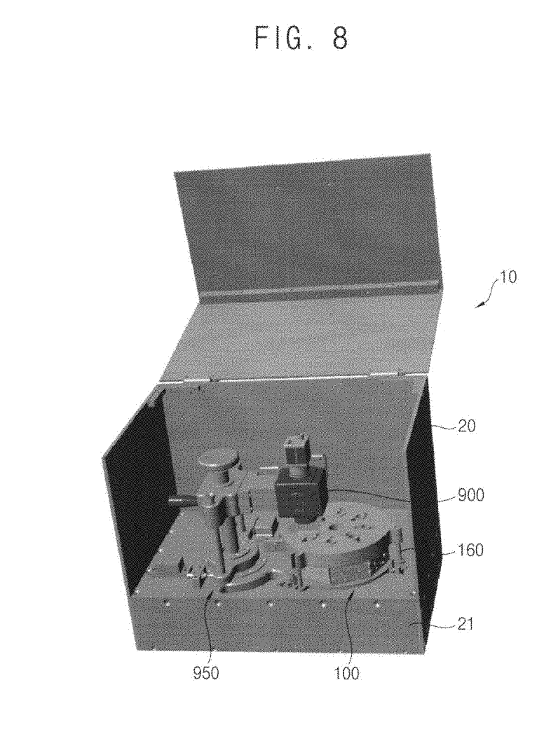

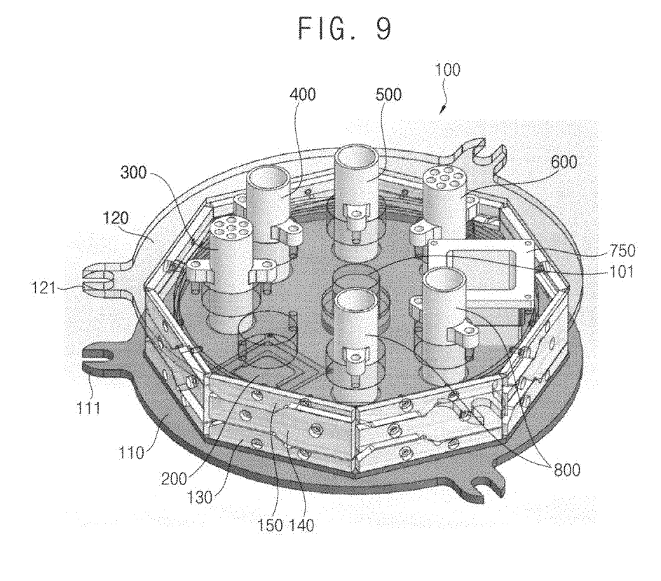

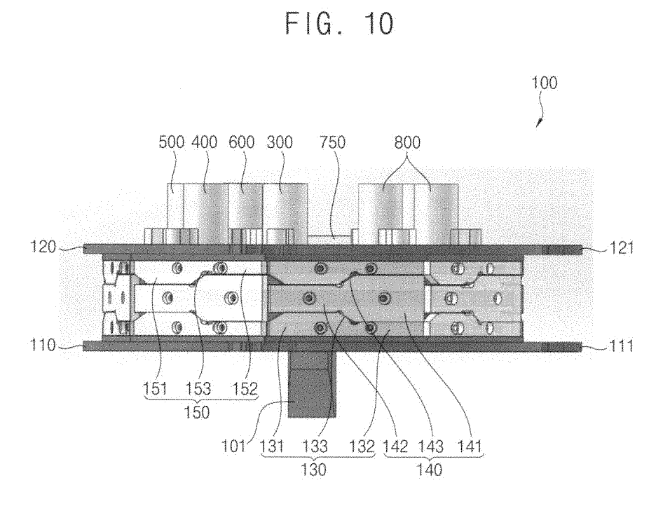

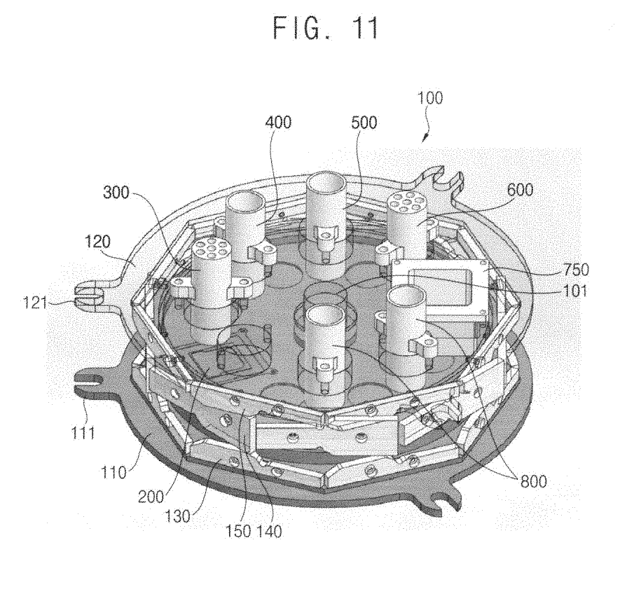

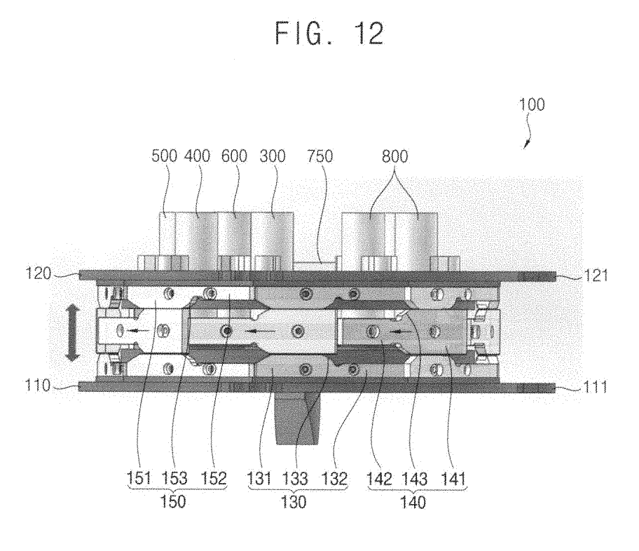

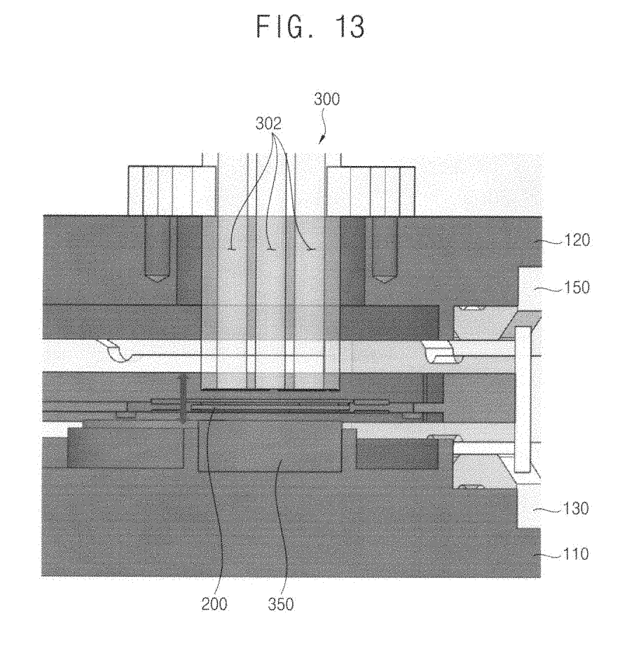

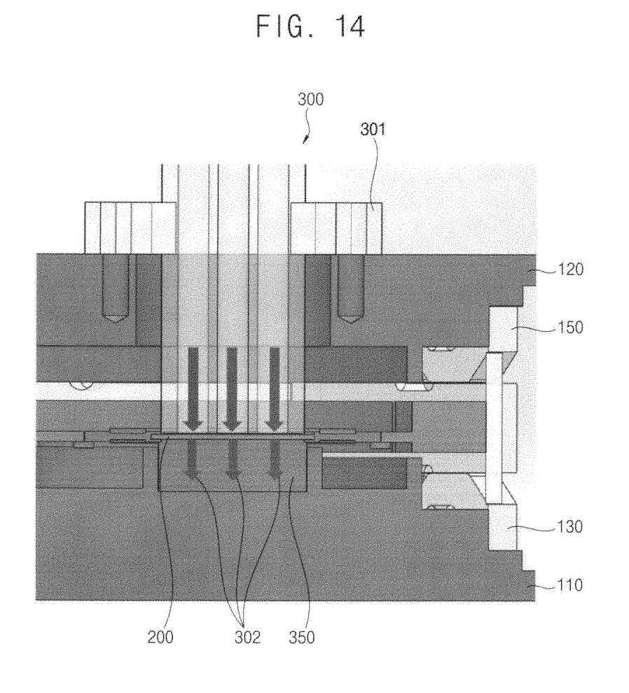

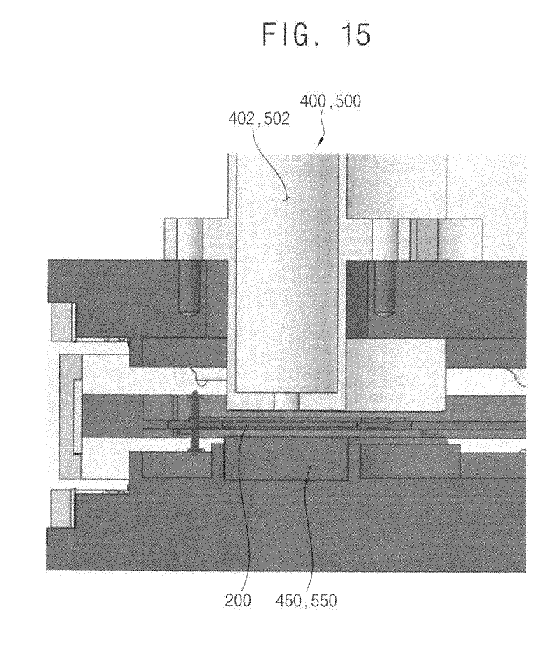

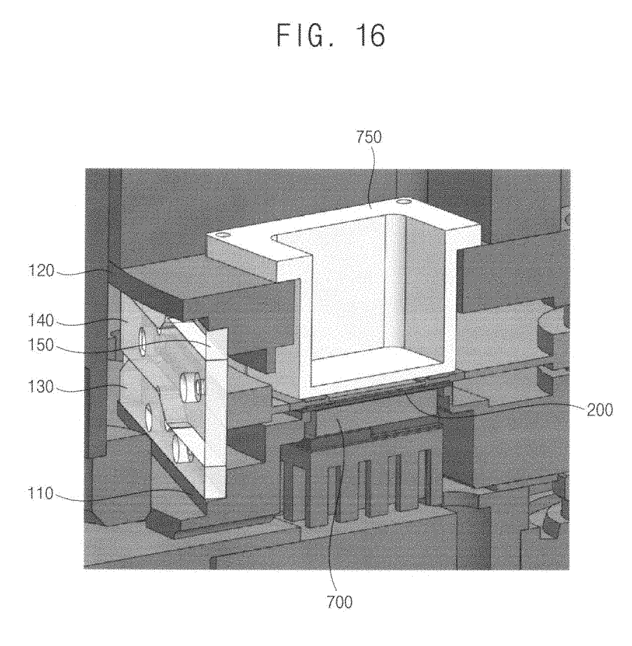

FIG. 8 is a perspective view illustrating a multi molecular diagnosis apparatus according to still another example embodiment of the present invention. FIG. 9 is a perspective view illustrating a rotating frame unit of FIG. 8 with a fixed state. FIG. 10 is a side view illustrating the rotating frame unit of FIG. 9. FIG. 11 is a perspective view illustrating the rotating frame unit of FIG. 8 with a rotated state. FIG. 12 is a side view illustrating the rotating frame unit of FIG. 11. FIG. 13 is an enlarged view illustrating a pretreatment and collector with the rotating frame unit of FIG. 8 rotated. FIG. 14 is an enlarged view illustrating the rotating frame unit of FIG. 8 with a collected state. FIG. 15 is an enlarged view illustrating a cleaner with the rotating frame unit of FIG. 8 rotated. FIG. 16 is an enlarged view illustrating the rotating frame unit of FIG. 8 with a heated state.

The multi molecular diagnosis apparatus 30 (hereinafter, so called as apparatus) is an example performed using the system 10 mentioned above, and thus same reference numerals are used for same elements and any repetitive explanation will be omitted. Thus, the elements same as in the system 10 have same structures, functions, arrangements and so on, if there are no explanations on the elements.

Referring to FIGS. 8 to 16, the apparatus according to the present example embodiment includes an outer frame 20, a rotating frame 100, a card part 200, a pretreatment and collector 300, a first cleaner 400, a second cleaner 500, a reagent unit 600, a heater 700 (FIG. 16), an optical unit 900 and an optical fixing frame 950, and as explained above, may further include a specimen absorber 350, first and second cleaning liquid absorbers 450 and 550, and a reagent absorber 650.

In addition, a base frame 21 is positioned inside of the outer frame 20, and the rotating frame 100, the optical unit 900 and the optical fixing unit 950 are fixed via the base frame 21.

Structures, functions, arrangements and so of the elements of the apparatus 300 are substantially same as those of the elements of the system 100, and any repetitive explanation will be omitted.

Thus, hereinafter, additional characteristic or detailed structures of the apparatus 300 are explained in detail as the system 10 is performed as an apparatus.

The rotational frame 100 is positioned at a center of an inner space of the outer frame 20, and is rotated with respect to a central axis 101. The rotational frame 100 has a circular plate shape and has a predetermined thickness, and the card part 200 is positioned at a side of the rotational frame 100. Here, the rotational frame 100 will be explained below in detail.

In addition, as illustrated in FIG. 9, temporary units 800 are additionally aligned and are positioned, so that any additional processes may be performed via the temporary units 800, when needed.

In addition, in the present example embodiment, as explained for the system 10, the card part 200 rotates with the rotational frame 100 and is positioned at each of the pretreatment and collector 300, the first cleaner 400, the second cleaner 500, the reagent unit 600 and the heater 700. In addition, as positioned at each unit, the card part 200 is tightly adhered to each of the units for the specimen, the cleaning liquid and the reagents to pass through the card part 200.

However, the card part 200 is a paper like the ‘Whatman FTA card’, and thus may be damaged easily due to the repeated rotation and the attachment.

Thus, except when the card part 200 is adhered to the diagnosis units, the card part 200 would better not to be adhered to other units or frames in rotating with the rotating frame 100.

Accordingly, in the present example embodiment, when the card part 200 is moved and rotated with the rotating frame 100, a moving space is formed for the card part 200 not to be contacted with the units or the frames, and thus the card part 200 is only adhered to the diagnosis units when positioned aligned with the diagnosis units.

Hereinafter, the above rotating mechanism will be explained in detail.

Referring to FIGS. 8 to 10, the rotating frame 100 includes a lower surface frame 110, an upper surface frame 120, a lower frame 130, a central frame 140, an upper frame 150 and a vertical fixing guide 160.

The lower surface frame 110 is fixed to a base frame 21 of the outer frame 20, and has a circular plate shape. A plurality of lower surface fixing members 111 is protruded from a circumferential surface.

The upper surface frame 120 faces the lower surface frame 110, and has the shape substantially same as that of the lower surface frame 110. A plurality of upper surface fixing members 121 is protruded from a circumferential surface and is aligned with the plurality of lower surface fixing members 111, respectively.

A first end of the vertical fixing guide 160 is fixed to the base frame 21 and extends vertically, and fixes the lower surface fixing members 111 of the lower surface frame 110 and the upper surface fixing members 121 of the upper surface frame 120.

Here, the lower surface fixing members 111 are fixed to the vertical fixing guide 160, but the upper surface fixing members 121 are combined to be movable up and down along the vertical fixing guide 160. Thus, the upper surface frame 120 is guided and moved up and down by the vertical fixing guide 160.

The lower frame 130 is protruded from the lower surface frame 110, in a vertical direction to the lower surface frame 110, and the upper frame 150 is protruded from the upper surface frame 120 in a vertical direction to the upper surface frame 120. The central frame 140 is disposed between the lower frame 130 and the upper frame 150.

Thus, the lower frame 130, the central frame 140 and the upper frame 150 form a side surface to make up for a space between the lower surface frame 110 and the upper surface frame 120, in a whole.

Here, referring to FIG. 9, the lower frame 130, the central frame 140 and the upper frame 150 may have a polygonal shape (an octagon in FIG. 9) in a whole when viewed from an upper position. Each of the lower frame 130, the central frame 140 and the upper frame 150 forms a side surface in the polygonal shape (an octagonal column in FIG. 9).

Each of the lower frame 130 and the upper frame 150 is fixed to each of the lower surface frame 110 and the upper surface frame 120, and the central frame 150 is connected to the central axis 101 to be rotated with the rotation of the central axis 101.

Here, the card part 200 is fixed to the central frame 150, and then as the central frame 150 is rotated with the rotation of the central axis 101, the card part 200 is also rotated.

In addition, the pretreatment and collector 300, the first cleaner 400, the second cleaner 500, the reagent unit 600, the optical frame 750 and the temporary units 800 pass through the upper surface frame 120 and the upper frame 150, and are fixed to the upper frame 150.

Thus, as explained below, with the up and down movement of the upper frame 150, the pretreatment and collector 300, the first cleaner 400, the second cleaner 500, the reagent unit 600, the optical frame 750 and the temporary units 800 move up and down at the same time.

Further, the specimen absorber 350, the first and second cleaning liquid absorbers 450 and 550, the reagent absorber 650 and the heater 700 pass through the lower surface frame 110 and the lower frame 130, and are fixed to the lower frame 130.

In addition, as the central frame 150 rotates, the upper frame 150 and the upper surface frame 120 repeatedly move up and down along the vertical fixing guide 160, due to the shape of each of the lower frame 130, the central frame 140 and the upper frame 150. Thus, when the card part 200 is rotated and moved, the space for moving the card part 200 is formed. In addition, when the card part 200 is positioned at one of the diagnosis units, the card part 200 is tightly adhered to one of the diagnosis units.

For example, the lower frame 130 includes a lower convex portion 131 and a lower concave portion 132, at every side surface of the polyprism formed by the lower frame 130. Here, the lower convex portion 131 is protruded with a first height, and the lower concave portion 132 is protruded with a second height lower than the first height.

Here, a first inclined surface 133 is formed between the lower convex portion 131 and the lower concave portion 132, and thus the lower convex portion 131 is connected to the lower concave portion 132.

In addition, the central frame 140 includes a central convex portion 141 and a central concave portion 142, at every side surface of the polyprism formed by the central frame 140. Here, the central convex portion 141 is protruded with a third height, and the central concave portion 142 is protrude with a forth height lower than the third height.

Here, a second inclined surface 143 is formed between the central convex portion 141 and the central concave portion 142, and thus the central convex portion 141 is connected to the central concave portion 142.

Likewise, the upper frame 150 includes an upper convex portion 151 and an upper concave portion 152, at every side surface of the polyprism formed by the upper frame 150. Here, the upper convex portion 151 is protruded with a fifth height, and the upper concave portion 152 is protruded with a sixth height lower than the fifth height.

Here, a third inclined surface 153 is formed between the upper convex portion 151 and the upper concave portion 152, and thus the upper convex portion 151 is connected to the upper concave portion 152.

As illustrated in FIGS. 9 and 10, the sum of the heights of the lower convex portion 131, the central concave portion 142 and the upper convex portion 151 is substantially same as that of the lower concave portion 132, the central convex portion 141 and the upper concave portion 152, at every side surface of the polyprism formed by the upper frame 150, the central frame 140 and the lower frame 130.

The sum of the first, fourth and fifth heights is substantially same as that of the second, third and sixth heights.

Thus, as illustrated in FIGS. 9 and 10, the side surface of the rotating frame 200 is enclosed.

In addition, as illustrated in FIGS. 9 and 10, when the side surface of the rotating frame 200 is enclosed, which means that the lower convex portion 131, the central concave portion 142 and the upper convex portion 151 are aligned vertically, the card part 200 is positioned at each diagnosis unit and each diagnosis process is performed.

In the position as illustrated in FIGS. 9 and 10, the card part 200 is tightly adhered to the pretreatment and collector 300 and receives the specimen (referring to FIG. 14), the card part 200 is tightly adhered to the first and second cleaner 400 and 500 and receives the cleaning liquid, the card part 200 is tightly adhered to the reagent unit 600 and receives the reagent, or the card part 200 is tightly adhered to the heater 700 and the virus is amplified (referring to FIG. 16). In addition, as illustrated in FIG. 16, when the amplification of the virus is completed, the optical unit 900 detects the virus at the position as illustrated in FIGS. 9 and 10.

Although FIG. 9 illustrates the card part 200 not moved to the pretreatment and collector 300, the upper surface frame 110, the lower surface frame 120, the upper frame 150, the central frame 140 and the lower frame 130 are positioned as illustrated in FIG. 10, and the above explanation will be applied, when the card part 200 is rotated to be tightly adhered to the lower surface of each of the diagnosis units.

Alternatively, referring to FIGS. 11 and 12, when the central frame 140 is in the rotating state, the upper frame 150 is pushed upwardly by the central frame 140 and is lifted up (or is moved upwardly) along the vertical fixing guide 160.

Referring to FIGS. 10 and 12, when the central frame 140 is rotated along a direction illustrated as an arrow in FIG. 12, the second inclined surface 133 of the central frame 140 is lifted up along the first inclined surface 133 of the lower frame 130, and the third inclined surface 153 of the upper frame 150 is lifted up along the second inclined surface 133 of the central frame 140, at the same time.

Then, the central frame 140 and the upper frame 150 are positioned at the position as illustrated in FIG. 12, and here, the height of the side surface of the rotating frame 100 is increased as the upper frame 150 is lifted up along the vertical fixing guide 160.

Then, when the central frame 140 is moved additional along the direction as the arrow, the central frame 140 is positioned from the prior side surface to the side surface along the arrow. Thus, the central frame 140 is positioned with overlapping with the upper and lower frames 150 and 130, and here, the upper frame 150 is lifted down (is moved downwardly) along the vertical guide 160 again.

The central concave portion 143 of the central frame 140 is aligned up and down with the lower convex portion 130 of the lower frame 130 and the upper convex protrusion 151 of the upper frame 150, and forms the side surface of the rotating frame 100.

Accordingly, as for the lower frame 130, the central frame 140 and the upper frame 150, the side surfaces thereof forming the polygon shape, the upper frame 150 and the central frame 140 are lifted up and down as the central frame 140 is rotated along the direction as the arrow. Finally, only the central frame 140 moves the side surface adjacent to the side surface of the initially formed polygon shape.

In addition, in the present example embodiments, when the central frame 140 is rotated, the central and the upper frames 140 and 150 are lifted. Then, the central frame 140 is spaced apart from the lower frame 130 to form a space, and the central frame 140 is spaced apart from the upper frame 150 to form a space.

As explained above, the card part 200 is fixed to the central frame 140, and the pretreatment and collector 300, the first cleaner 400, the second cleaner 500, the reagent unit 600, the optical frame 750 and the temporary units 800 are fixed to the upper frame 150. In addition, the specimen absorber 350, the first and second cleaning liquid absorbers 450 and 550, the reagent absorber 650 and the heater 700 are fixed to the lower frame 130.

Thus, when the central frame 140 is rotated, the card part 200 is spaced apart from the pretreatment and collector 300, the first cleaner 400, the second cleaner 500, the reagent unit 600, the optical frame 750 and the temporary units 800, in addition to the specimen absorber 350, the first and second cleaning liquid absorbers 450 and 550, the reagent absorber 650 and the heater 700.

As illustrated in FIG. 13, right before the central frame 140 stops rotating, the card part 200 is spaced apart from the pretreatment and collector 300 disposed upwardly, in addition to the specimen absorber 350 disposed downwardly.

Likewise, as illustrated in FIG. 15, right before the central frame 140 stops rotating, the card part 200 is spaced apart from the first and second cleaners 400 and 500 disposed upwardly, in addition to the first and second cleaning liquid absorbers 450 and 550 disposed downwardly.

Accordingly, the card part 200 is blocked to make contact with the adjacent units and thus is prevented to be damaged, when the central frame 140 is rotated.

Alternatively, as illustrated in FIG. 14, after the central frame 140 finishes rotating, the card part 200 is tightly adhered to the pretreatment and collector 300 disposed upwardly, in addition to the specimen absorber 350 disposed downwardly. Likewise, as illustrated in FIG. 16, after the central frame 140 finished rotating, the card part 200 is tightly adhered to the optical frame 750 disposed upwardly, in addition to the heater 700 disposed downwardly.

Accordingly, the card part 200 is tightly adhered to every unit for the diagnosis process during each diagnosis process is performed.

Referring to FIGS. 13 and 16, the rotating state and the stopped state of the central frame 140 are explained, with examples of the pretreatment and collector and the cleaner, but other diagnosis units are driven and operated with same mechanism.

As illustrated in FIG. 9, in the present example embodiment, the space in which the card part 200 does not make contact with the adjacent units is formed by the movement of the central frame 140 and the upper frame 150 upwardly, when the central frame 140 is rotating for the card part 200 to be moved under the pretreatment and collector 300. Then, after the card part 200 finishes moving and the card part 200 is disposed under the pretreatment and collector 300, the central frame 140 and the upper frame 150 are lifted down again, so that the card part 200 is tightly adhered to both of the pretreatment and collector 300 and the specimen absorber 350.

Then, after the specimen collecting process is finished, the central frame 140 is rotated again. Here, the space in which the card part 200 does not make contact with the adjacent units is formed by the movement of the central frame 140 and the upper frame 150 upwardly, when the central frame 140 is rotating for the card part 200 to be moved under the first cleaner 400. Then, after the card part 200 finishes moving and the card part 200 is disposed under the first cleaner 400, the central frame 140 and the upper frame 150 are lifted down again, so that the card part 200 is tightly adhered to both of the first cleaner 400 and the first cleaning absorber 450.

The above-mentioned driving and operating mechanism is repeatedly performed at every diagnosis process, as the card part sequentially moves in the second cleaner 500, the reagent unit 600 and the optical frame 750.

Then, even though the card part 200 is made of a paper which may be easily damaged and includes a liquid like the specimen, the card part 200 is prevented from being damaged and each process is stably performed.

According to the present example embodiments, each process is performed manually in the conventional paper molecular diagnosis, but in the present example embodiment, a series of processes are performed automatically in the molecular diagnosis, to enhance user's convenience.

In addition, the card part is rotated in the rotating frame, and each unit performing each process is arranged in a rotational shape, so that a total volume of the diagnosis system is minimized Thus, the diagnosis system may be performed to be portable and a relatively small size.

In addition, with other diagnosis units fixed in the position, the rotating frame in which the paper is positioned is rotated, and thus the system may be more simplified, the diagnosis speed may be increased and the system may be manufactured more easily.

Here, the rotation of the rotating frame forms the moving space in which the card part is to be moved, and the card part is attached to the unit when each diagnosis process is performed with the stop of the rotating frame, so that the card part may be prevented from being damaged and the diagnosis may be stably performed.

In addition, the diagnosis process is performed within an enclosed space, and thus second infection may be prevented.

In addition, in the conventional process of using the Whatman FTA card, a drying process is necessary in each process, but, in the present example embodiment, any drying process is unnecessary in an entire diagnosis process.

In addition, the unit providing the specimen, the cleaning liquid or the diagnosis reagent is disposed over the card part, and the unit absorbing the specimen, the cleaning liquid or the diagnosis reagent is disposed under the card part. Thus, the liquid from upside is effectively absorbed at the downside, so that the liquid easily passes through the card part and the diagnosis process may be performed more efficiently.

In addition, the card part is divided by a plurality of areas, and the specimen is prevented from being infiltrated from an adjacent area, so that the multi molecular diagnosis in which different reagents are used in every area may be performed.

In addition, the rotating frame is designed considering that a plurality of diagnosis processes is sequentially performed and the card part is repeatedly stopped and moved for each diagnosis process, so that the system is configured to be relatively simple structure to prevent the card part from being damaged and every diagnosis process is stably performed.

Here, the convex and concave portions of the central frame, the upper frame and the lower frame are alternately repeated, and the upper surface frame is moved up and down, so that the upper surface frame moves upwardly to form the moving space for the card part when the convex portion of the central frame makes contact with the convex portions of the lower and upper frames. Thus, the optimized multi molecular diagnosis apparatus may be provided, considering the characteristics of the multi molecular diagnosis system in which repeated moving spaces and the attaching are necessary.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A multi molecular diagnosis system comprising:
a card part moving in a rotating frame, and having a plurality of cards;
a pretreatment and collector providing a collected specimen to each card of the card part;
a cleaner providing a cleaning liquid to the card part, to clean the collected specimen in the card part;
a reagent unit providing a plurality of diagnosis reagents to each card of the card part;
a heater heating the card part absorbing the reagent, to clone a virus template; and
an optical unit observing the cloned virus template,
wherein the card part sequentially moves through the pretreatment and collector, the cleaner, the reagent unit, the heater and the optical unit.

2. The multi molecular diagnosis system of claim 1, further comprising:
a specimen absorber disposed under the pretreatment and collector, and absorbing the specimen passing through the card part;
a cleaning liquid absorber disposed under the cleaner, and absorbing the cleaning liquid passing through the card part; and
a reagent absorber disposed under the reagent unit, and absorbing the reagent passing through the card part.

3. The multi molecular diagnosis system of claim 2, wherein the card part is adhered between the pretreatment and collector and the specimen absorber, between the cleaner and the cleaning absorber, and between the reagent unit and the reagent absorber.

4. The multi molecular diagnosis system of claim 1, wherein the card part is fixed to the rotating frame, and the rotating frame is rotated with respect to a central axis.

5. The multi molecular diagnosis system of claim 4, wherein the card part is positioned under each of the pretreatment and collector, the cleaner, the reagent unit and the heater, as the rotating frame is rotated.

6. The multi molecular diagnosis system of claim 1, further comprising a card holder at which a plurality of cards is individually fixed,
wherein the card holder comprises a plurality of card areas, and each of the cards is fixed to each of the card areas.

7. The multi molecular diagnosis system of claim 1, wherein the pretreatment and collector receives the specimen from a tube upwardly, and provides the specimen to each of the cards individually.

8. The multi molecular diagnosis system of claim 7, wherein the pretreatment and collector comprises a plurality of needles respectively positioned at the cards.

9. The multi molecular diagnosis system of claim 7, wherein the pretreatment and collector comprises a plurality of collecting conduits disposed at the cards of the card part and connecting the tube to the cards, respectively.

10. The multi molecular diagnosis system of claim 1, wherein the reagent unit comprises a plurality of reagent conduits disposed at the cards of the card part and providing the reagents different from each other to the cards, respectively.

11. The multi molecular diagnosis system of claim 1, wherein the card part is FTA card.

12. The multi molecular diagnosis system of claim 1, wherein capillarity of a pore in the card is used, to control passing speeds of the specimen, the cleaning liquid and the diagnosis reagents.

13. A multi molecular diagnosis apparatus comprising:
a card part;
a pretreatment and collector providing a collected specimen to the card part;
a cleaner providing a cleaning liquid to the card part, to clean the collected specimen in the card part;
a reagent unit providing a diagnosis reagent to the card part;
a heater heating the card part absorbing the reagent, to clone a virus template; and
a rotating frame moving the card part to the pretreatment and collector, the cleaner, the reagent unit and the heater, and providing a moving space when the card part moves.

14. The multi molecular diagnosis apparatus of claim 13, wherein the rotating frame comprises:
a lower surface frame fixed at a base frame;
an upper surface frame facing the lower surface frame; and
a vertical fixing guide connecting the upper surface frame and the lower surface frame to the base frame.

15. The multi molecular diagnosis apparatus of claim 14, wherein the rotating frame further comprises:
a lower frame fixed to an upper surface of the lower surface frame;
an upper frame fixed to a lower surface of the upper surface frame; and
a central frame disposed between the lower frame and the upper frame, and rotating with respect to a central axis.

16. The multi molecular diagnosis apparatus of claim 15, wherein the upper surface frame moves up and down along the vertical fixing guide, as the central frame is rotated.

17. The multi molecular diagnosis apparatus of claim 16, wherein the upper surface frame moves upwardly to form a moving space of the card part, as the card part moves,
wherein the upper surface frame moves downwardly to attach the card part to one of the pretreatment and collector, the cleaner, the reagent unit and the heater, as the card part is attached.

18. The multi molecular diagnosis apparatus of claim 16, wherein a convex portion and a concave portion are alternately extended, at each of the lower frame, the upper frame and the central frame,
wherein the upper surface frame moves upwardly as the convex portions make contact with each other, and the upper surface frame moves downwardly as the convex portion makes contact with the concave portion.

19. The multi molecular diagnosis apparatus of claim 18, wherein an inclined surface is formed between the convex and concave portions, and thus the protrusion of the central frame moves along the inclined surface to make contact with the protrusion of the lower frame and the protrusion of the upper frame as the central frame is rotated.

20. The multi molecular diagnosis apparatus of claim 15, wherein the lower frame, the upper frame and the central frame form a side surface of a polyprism.
